(19) United States
(12) Patent Application Publication
(10) Pub. No.: US 2021/0309918 A1
(43) Pub. Date: Oct. 7, 2021

(54) Successive Thermal Pyrolysis Apparatus for Waste Rubber

(71) Applicant: Plainstone Pyrolysis Solutions, LLC, Covina, CA (US)

(72) Inventor: Chien Hsiung Chang, Kaohsiung City (TW)

(21) Appl. No.: 16/837,098

(22) Filed: Apr. 1, 2020

(51) Int. Cl. C10B 7/06; C10B 53/07; C10B 5/10

(52) U.S. Cl. CPC C10B 7/06; C10B 5/10; C10B 53/07

(57) ABSTRACT

A successive thermal pyrolysis apparatus for waste rubber has a pyrolysis furnace unit and a steam heating unit. The pyrolysis furnace unit is a tube chain type pyrolysis furnace and substantially has conveyor tubes and a chain disc conveyor mounted through the conveyor tubes for conveying waste rubber along the conveyor tubes. The steam heating unit encloses a segment of the conveyor tubes and has multiple baffles mounted therein to form a tortuous flowing path for steam passing through to heat the pyrolysis furnace unit. The successive thermal pyrolysis apparatus can prevent the carbonized fragments from sticking to and blocking inner surfaces of the conveyor tubes. The waste rubber fragments are successively thermally decomposed while being conveyed through the conveyor tubes.

### BACKGROUND OF THE INVENTION

### 1. Field of the Invention

The present invention relates to a thermal pyrolysis apparatus to decompose waste rubber or waste tires.

### 2. Description of Related Art

Thermal pyrolysis of waste tires or waste rubber offers a method for transforming waste rubber or waste tires into useful products, e.g. pyrolysis oil and pyrolysis carbon blacks. The waste rubber and the waste tires are heated in a reactor vessel containing an oxygen-free atmosphere to produce pyrolysis oil and pyrolysis carbon blacks.

A conventional thermal pyrolysis apparatus for waste rubber substantially has a pyrolysis furnace and a spiral conveyor having a spiral rod disposed in the pyrolysis furnace. The spiral conveyor conveys carbon blacks decomposed from the waste rubber or tire fragments to an outlet of the pyrolysis furnace. The waste rubber or tire fragments are carbonized during thermal decomposition. Carbonized fragments may stick to the spiral rod and a furnace surface to block a conveying passage in the furnace. The conveying efficiency is reduced. After several thermal pyrolysis processes, the carbonized fragments blocking in the pyrolysis furnace need to be removed, but the carbonized fragments sticking to the spiral rod are difficult to be removed.

To overcome the shortcomings, the present invention tends to provide a successive thermal pyrolysis apparatus for waste rubber to mitigate or obviate the aforementioned problems.

### SUMMARY OF THE INVENTION

The main objective of the invention is to provide a successive thermal pyrolysis apparatus for waste rubber which can prevent carbonized fragments from blocking a conveying passage during thermal pyrolysis process.

A successive thermal pyrolysis apparatus applied for waste rubber comprises a pyrolysis furnace unit and a steam heating unit.

The pyrolysis furnace unit has a first end, a second end, two conveyor tubes, a chain disc conveyor, a rubber entry tube, a connecting tube, a carbon export tube and an oil gas outlet tube.

The conveyor tubes extend along a connecting line from the first end to the second end and are respectively defined as an upper conveyor tube disposed near the top of the pyrolysis furnace unit and a lower conveyor tube disposed below the upper conveyor tube.

The chain disc conveyor has multiple discs, multiple chains, two sprockets, and a driving device. The discs are mounted in and arranged along the conveyor tubes at spaced intervals. The chains link the discs to form a chain loop extending through the conveyor tubes. The sprockets are respectively disposed near the first end and the second end and engaged with the chain loop. The driving device is connected to one of the sprockets and drives the sprocket to convey the discs moving along the upper conveyor tube from the first end to the second end and moving along the lower conveyor tube from the second end to the first end.

The rubber entry tube is connected and communicates with the upper conveyor tube at a position near the first end. The connecting tube is connected and communicates with the upper and the lower conveyor tubes at a position spaced from the rubber entry tube near the second end. The carbon export tube is connected to and communicates with the lower conveyor tube at a position away from the connecting tube near the first end. The oil gas outlet tube is mounted on the top of the pyrolysis furnace unit and communicates with the conveyor tubes.

The steam heating unit encloses a segment of the conveyor tubes between the first end and the second end and has a steam heating chamber, a steam input, a steam output, and multiple baffles.

The steam heating chamber encloses the segment of the conveyor tubes to form a heating space surrounding the segment of the conveyor tubes. The steam input and the steam output communicate with the steam heating chamber and are respectively disposed near opposite ends of the steam heating chamber. The baffles are arranged along the conveyor tubes at spaced intervals and arranged in staggered arrays to form a tortuous flowing path in the steam heating chamber from the steam input to the steam output.

Other objects, advantages and novel features of the invention will become more apparent from the following detailed description when taken in conjunction with the accompanying drawings.

### BRIEF DESCRIPTION OF THE DRAWINGS

FIG. 1 is a side view of an embodiment of a successive thermal pyrolysis apparatus for waste rubber in accordance with the present invention;

FIG. 2 is a side view in partial section of the successive thermal pyrolysis apparatus in FIG. 1;

FIG. 3 is an enlarged cross sectional end view of the successive thermal pyrolysis apparatus in FIG. 1;

FIG. 4 is a side view in partial section of the pyrolysis furnace unit of the successive thermal pyrolysis apparatus in FIG. 1;

FIG. 5 is an operational side view of a successive thermal pyrolysis system with the successive thermal pyrolysis apparatus in FIG. 1;

FIG. 6 is an operational side view in partial section of the pyrolysis furnace unit of the successive thermal pyrolysis apparatus in FIG. 4;

FIG. 7 is an operational side view in partial section f of the successive thermal pyrolysis apparatus in FIG. 2;

FIG. 8 is an enlarged cross sectional end view of the successive thermal pyrolysis apparatus in FIG. 2 showing porous metal fillings filled in the steam heating chamber; and

FIG. 9 is a perspective view of the porous metal filling filled in the steam heating chamber in FIG. 8.

### DETAILED DESCRIPTION OF PREFERRED EMBODIMENT

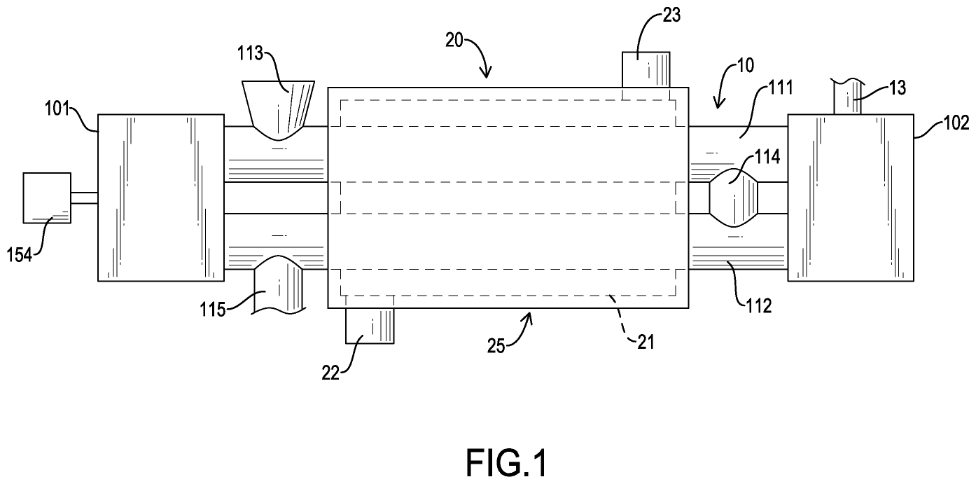

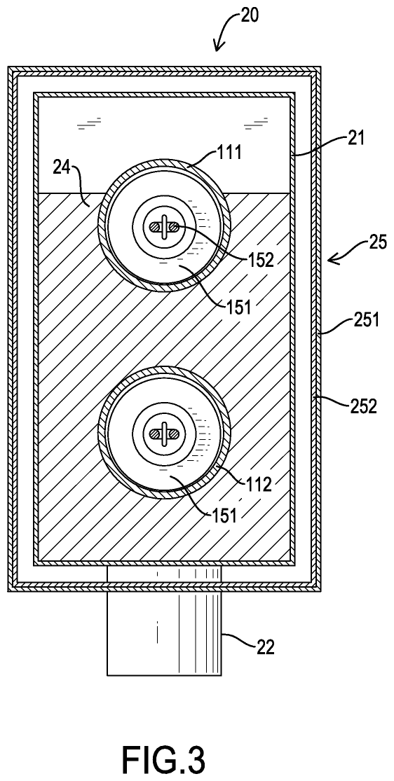

With reference to FIGS. 1 to 3, an embodiment of a successive thermal pyrolysis apparatus for waste rubber has a pyrolysis furnace unit 10 and a steam heating unit 20.

With reference to FIGS. 1, 3 and 4, the pyrolysis furnace unit 10 is a tube chain type pyrolysis furnace and has a first end 101, a second end 102, two conveyor tubes 111, 112, a chain disc conveyor 15, a rubber entry tube 113, a connecting tube 114, a carbon export tube 115, and an oil gas outlet tube 13.

The conveyor tubes 111,112 are circular tubes and transversely extend along a connecting line from the first end 101 to the second end 102. The conveyor tubes 111, 112 are respectively defined as an upper conveyor tube 111 disposed near a top of the pyrolysis furnace unit 10 and a lower conveyor tube 112 disposed below the upper conveyor tube 111. The lower conveyor tube 112 is parallel to the upper conveyor tube 111.

The chain disc conveyor 15 is mounted through the conveyor tubes 111, 112 and has multiple discs 151, multiple chains 152, two sprockets 153, and a driving device 154. The discs 151 are mounted in and arranged along the conveyor tubes 111, 112 at even spaced intervals. The outer diameter of the disc 151 is slightly smaller than the inner diameter of the upper and the lower conveyor tubes 111, 112. The discs 151 are vertically disposed in the conveyor tubes 111,112, and bottom edges of the discs 151 abut inner bottom edges of the conveyor tubes 111, 112. While moving along the conveyor tubes 111, 112, the discs 151 push waste rubber fragments or waste tire fragments filled in the conveyor tubes 111, 112 along the conveyor tubes 111,112. The chains 152 link the discs 151 to form a chain loop extending through the upper and the lower conveyor tubes 111, 112.

The sprockets 153 are rotatably engaged with the chain loop and are mounted in the pyrolysis furnace unit 10 respectively near the first end 101 and the second end 102. Each sprocket 153 has multiple teeth and multiple recesses formed around the sprocket 153. The teeth of the sprocket 153 are engaged with chain holes of the chains 152. The recesses of the sprocket 153 provide spaces for placing the discs 151. The driving device 154 is connected to one of the sprockets 153 and drives the sprocket 153 to rotate. While rotating, the sprocket 153 drives the chain loop to convey the discs 151 to move along the upper conveyor tube 111 from the first end 101 to the second end 102 and to move along the lower conveyor tube 112 from the second end 102 to the first end 101.

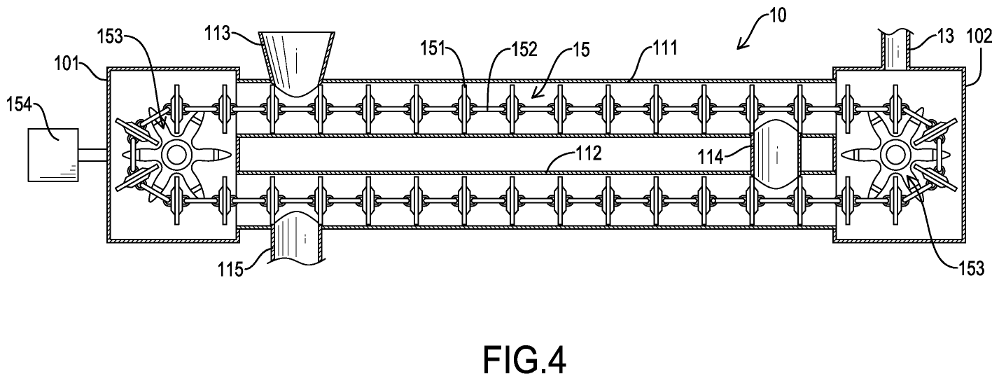

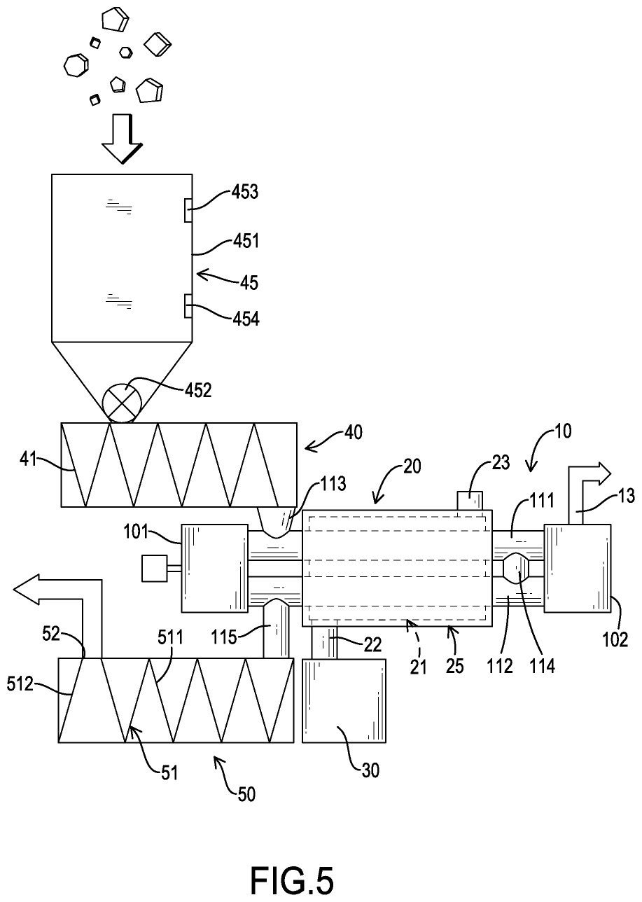

With reference to FIGS. 4 and 5, the rubber entry tube 113 is connected to and communicates with the upper conveyor tube 111 on the top side of the upper conveyor tube 111 at a position near the first end 101. The rubber entry tube 113 is connected to a feeding unit 40 with airproof connection. The feeding unit 40 can covey waste rubber fragments or waste tire fragments into the upper conveyor tube 111 in the absence or lack of oxygen via the rubber entry tube 113.

The connecting tube 114 is disposed between, is connected to, and communicates with the upper conveyor tube 111 and the lower conveyor tube 112 at a position spaced from the rubber entry tube 113 and near the second end 102. The waste rubber fragments or the waste tire fragments inside the upper conveyor tube 111 can drop into the lower conveyor tube 112 via the connecting tube 114.

The carbon export tube 115 is connected to and communicates with the lower conveyor tube 112 at the bottom of the lower conveyor tube 112 and at a position away from connecting tube 114 near the first end 101. The carbon export tube 115 is connected to a discharge unit 50 with airproof connection. The discharge unit 50 can collect the carbon blacks in the absence or lack of oxygen via the carbon export tube 115.

The oil gas outlet tube 13 is mounted on the top of the pyrolysis furnace unit 10 and communicates with the conveyor tubes 111, 112 at a position near the second end 102. The oil gas outlet tube 13 is located between the second end 102 and the connecting tube 114. The oil gas outlet tube 13 is connected to an oil gas collecting unit for collecting the oil gas after rubber thermal pyrolysis.

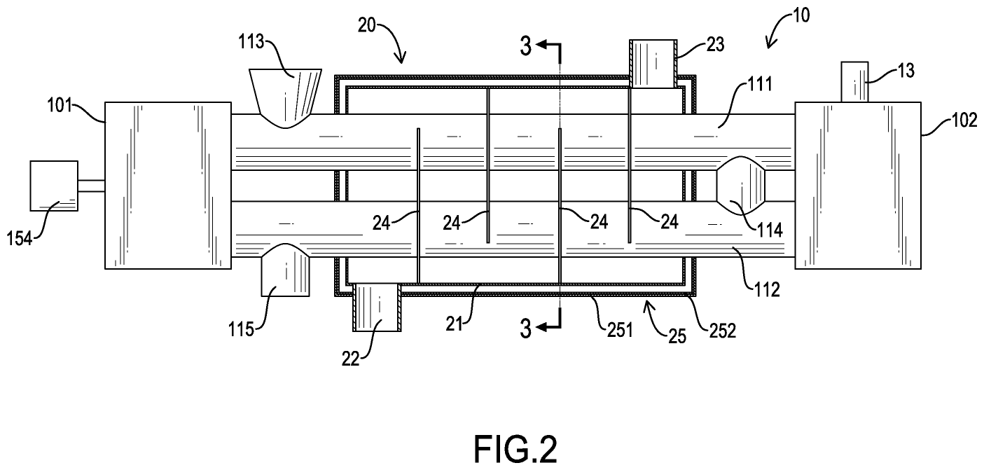

With reference to FIGS. 2, 3, and 5, the steam heating unit 20 encloses a segment of the upper and the lower conveyor tubes 111, 112 between the first end 101 and the second end 102. In the embodiment, the steam heating unit 20 encloses the conveyor tubes 111, 112 between the rubber entry tube 113 and the connecting tube 114. The steam heating unit 20 has a steam heating chamber 21, a steam input 22, a steam output 23, and multiple baffles 24.

The steam heating chamber 21 encloses the segment of the conveyor tubes 111, 112 to form a heating space surrounding the segment of the conveyor tubes 111, 112. The conveyor tubes 111, 112 are mounted through the steam heating chamber 21. The steam input 22 and the steam output 23 communicate with the steam heating chamber 21 and are respectively disposed near opposite ends of the steam heating chamber 21. The steam input 22 is mounted on the bottom of the steam heating chamber 21 near the first end 101 and connected to a boiler unit 30. Vaporized fluid or steam generated from the boiler unit 30 flows into the steam heating chamber 21 via the steam input 22 to heat the waste rubber fragments or the waste tire fragments in the conveyor tubes 111, 112 in the absence or lack of oxygen. The temperature of the vaporized fluid or steam for heating the waste rubber fragments or the waste tire fragment is around 600 to 800 degrees Celsius. The steam output 23 is mounted on the top of the steam heating chamber 21 near the second end 102 for the vaporized fluid or the steam flowing out from the steam heating chamber 21.

The baffles 24 are mounted in the steam heating chamber 21 and are arranged along the upper conveyor tube 111 at spaced intervals and are arranged in staggered arrays to form a tortuous flowing path in the steam heating chamber 21 from the steam input 22 to the steam output 23. In the embodiment, some of the baffles 24 abut the bottom and opposite sides of the steam heating chamber 21 and are spaced from the top thereof, and the other of the baffles 24 abut the top and opposite sides of the steam heating chamber 21 and are spaced from the bottom thereof. The baffles 24 spaced from the bottom of the steam heating chamber 21 and the baffles 24 spaced from the top of the steam heating chamber 21 are in a staggered arrangement. The baffles 24 guide the flowing direction of the steam and increase the length of the flowing path for the steam flowing through. The steam sequentially flows through the space formed between the baffles 24 from the steam input 22 to the steam output 23 to prolong the staying time and the heat transferring time of the steam.

Preferably, the steam heating unit 20 has a thermal insulating layer 25 covering and surrounding the steam heating chamber 21 to prevent the heat inside the steam heating chamber 21 from transferring to outside and to keep the steam heating chamber 21 at a high temperature. The thermal insulating layer 25 has an outer layer 251 made of carbon steel and an inner layer 252 made of ceramic fiber.

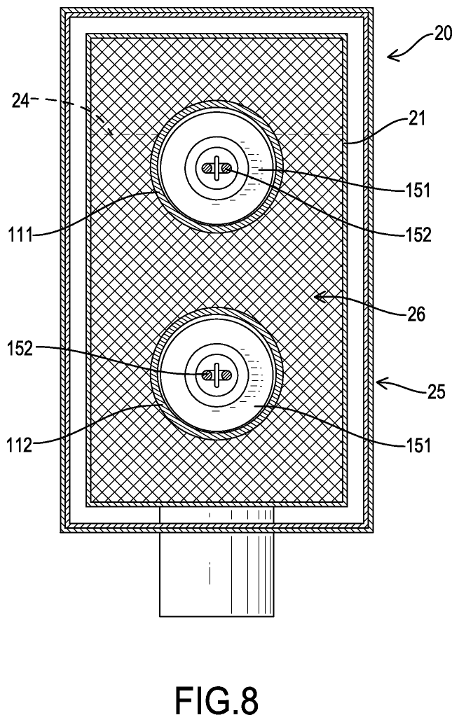

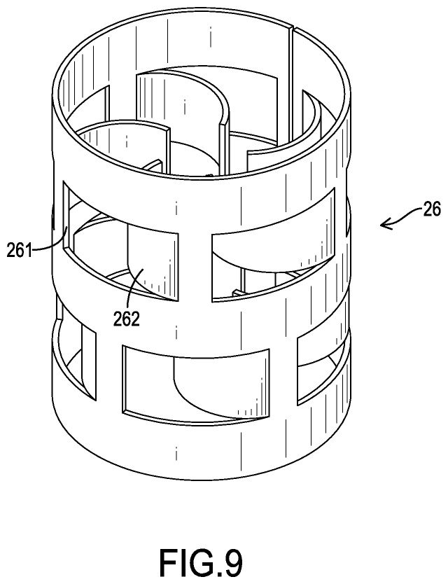

With reference to FIGS. 8 and 9, preferably, the steam heating chamber 21 has multiple porous metal fillings 26 filled in the heating space surrounding the conveyor tubes 111, 112. The porous metal fillings 26 are filled in the space formed between the baffles 24 and the upper and the lower conveyor tubes 111, 112. The steam or the vaporized fluid may flow through the porous metal fillings 26 and heat transfers with the porous metal fillings 26. With reference to FIG. 9, the porous metal filling 26 may be tubular and has multiple holes 261 formed therethrough and multiple fins 262 bending toward the inner side thereof. When the steam flows through and heat transfers with the porous metal fillings 26, the porous metal fillings 26 can retain and store the heat to enhance the heat retention of the steam heating chamber 21. The porous metal fillings 26 can prolong heating time of the steam heating chamber 21.

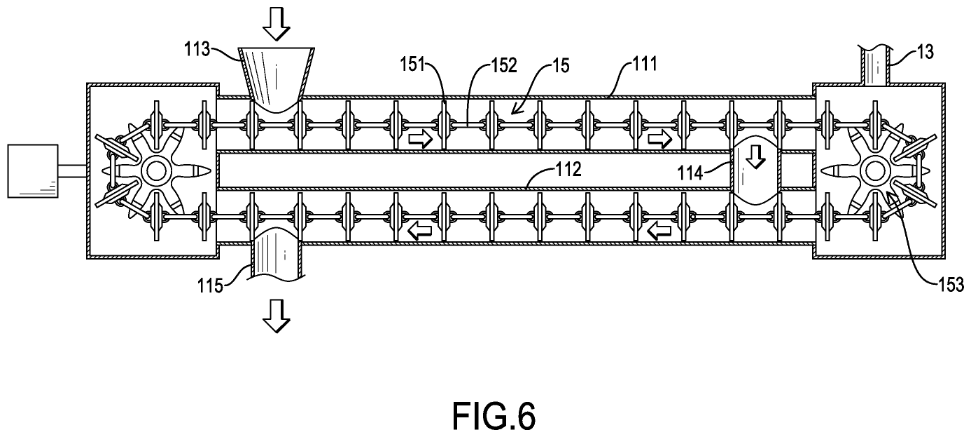

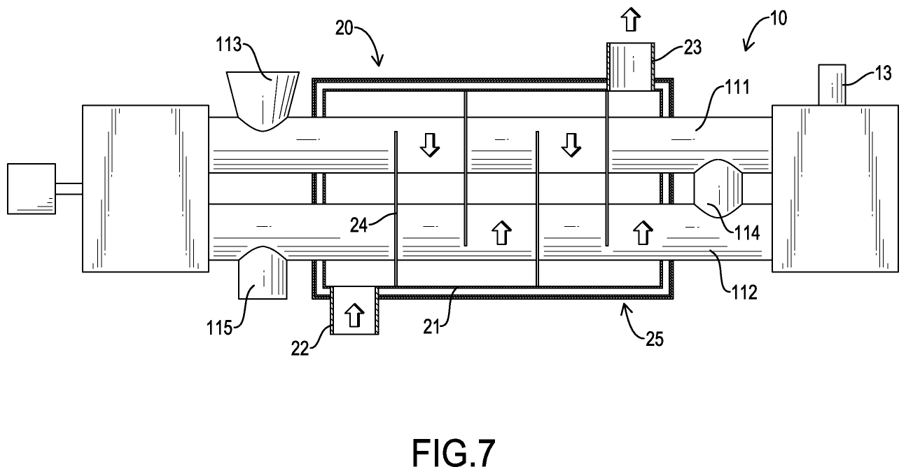

With reference to FIGS. 5 to 7, to feed the waste rubber fragments or the waste tire fragments into the pyrolysis in absence, the feeding unit 40 is connected to a receiving unit 45 via an airproof valve 452. The receiving unit 45 has a receiving chamber 451. The airproof valve 452 is mounted in the bottom of the receiving chamber 451. When waste rubber fragments or the waste tire fragments are gradually filled into the receiving chamber 451 of the receiving unit 45 to a preset height to be detected by height sensors 453, 454, the airproof valve 452 is opened, and the waste rubber fragments drop into the feeding unit 40 with less air flowing into the feeding unit 40. When the sensor 454 near the bottom of the receiving chamber 451 detects no waste rubber fragments, the airproof valve 452 is closed to prevent the air flowing into the feeding unit 40.

The feeding unit 40 has a spiral rod conveyor 41 to convey the waste rubber fragments to the rubber entry tube 113. The waste rubber fragments drop into the upper conveyor tube 111 via the rubber entry tube 113, and are conveyed along the upper conveyor tube 111 from the rubber entry tube 113 to the connecting tube 114 by pushing of the discs 151 of the chain disc conveyor 15. Then, the waste rubber fragments drop into the lower conveyor tube 112 via the connecting tube 114, and are conveyed along the lower conveyor tube 112 from the connecting tube 114 to the carbon export tube 115 by the pushing of the discs 151 of the chain disc conveyor 15.

While the waste rubber fragments are conveyed along the conveyor tubes 111, 112, the waste rubber fragments are heated in the absence or lack of oxygen by steam flowing through the steam heating chamber 21. The waste rubber fragments are decomposed to carbon blacks and oil gas. The carbon blacks are discharged from the carbon export tube 115 to the discharge unit 50. The oil gas flows out of the pyrolysis furnace unit 10 via the oil gas outlet tube 13. The oil gas is collected for cooling down to separate pyrolysis oil and pyrolysis gas.

The discharge unit 50 has a spiral rod conveyor 51 and an export opening 52. The spiral rod conveyor 51 has a first spiral segment 511 and the second spiral segment 512. The second spiral segment 512 is connected to the first spiral segment 511 and is spiral in reverse with respect to the first spiral segment 511. The export opening 52 is formed on the top of the discharge unit 50 where the first spiral segment 511 and the second spiral segment 512 are connected with each other. The carbon blacks can be pushed out from the export opening 52 by the spiral rod conveyor 51. Because of reversed spiral directions of the first and the second spiral segments 511, 512, air can be prevented from flowing into the discharge unit 50 while discharging the carbon black.

The high temperature steam from the boiler unit 30 sequentially flows through the steam input 22, the tortuous flowing path formed in the steam heating chamber 21, which is separated by the baffles 24, and the steam output 23 to heat the waste rubber fragments conveyed along the conveyor tubes 111, 112. The heat of the steam is transferred to the pyrolysis furnace unit 10 to heat the waste rubber fragments, and is transferred to the porous metal fillings 26 filled in the steam heating chamber 21 to retain the heat inside the steam heating chamber 21 for a longer period of time. After heat is transferred, the lower temperature steam is exhausted via the steam output 23.

The waste rubber fragments and the waste tire fragments can be decomposed and produce pyrolysis oil (43%), carbon blacks (33%), pyrolysis gas (15%), and metal (residual) by the successive thermal pyrolysis apparatus. The pyrolysis gas can be recycled into the thermal pyrolysis system as fuel for the thermal pyrolysis process. A specific gravity of the pyrolysis oil is 0.92±0.05. The fuel calorific value of the pyrolysis oil is from 9800 to 10200 kcal/kg. The iodine absorption of the carbon blacks is 85±10 g/kg. Dibutyl phthalate (DBP) absorption of the carbon blacks is 70±10⁻⁵m³/kg. The carbon blacks pyrolysis from the waste rubber fragments by the successive thermal pyrolysis apparatus is similar to N-300 series carbon blacks of ASTM (American Society for Testing and Materials).

With such arrangements, the waste rubber fragments are conveyed along the conveyor tubes 111, 112 by the chain disc conveyor 15 for successive thermal pyrolysis. Because the discs 151 are perpendicular to the conveyor tubes 111, 112, carbonized fragments does not easy stick to the discs 151. While moving, the discs 151 can scrape the carbonized fragments sticking to the surface of the conveyor tubes 111, 112 and push the carbonized fragments moving along the conveyor tubes 111, 112. The blocking by the carbonized fragments is reduced. The waste rubber fragments can be heated evenly and can be conveyed stably to enhance thermal pyrolysis efficiency and stability.

The residing time of steam inside the steam heating chamber 21 can be prolonged by the baffles 24 arranged in the steam heating chamber 21. The heat transfer of steam in the steam heating chamber 21 is longer. The stable heating temperature of the steam heating chamber 21 can be provided. The heating efficiency of the steam heating unit 20 can be enhanced. The waste rubber fragments can be decomposed under lower temperature to reduce the pyrolysis furnace unit 10 being damaged and to reduce energy waste in the pyrolysis process.

What is claimed is:

1. A successive thermal pyrolysis apparatus applied for waste rubber comprising:
a pyrolysis furnace unit having
a top;
a bottom;
a first end;
a second end;
two conveyor tubes extending along a connecting line from the first end to the second end and respectively defined as an upper conveyor tube disposed near the top of the pyrolysis furnace unit and a lower conveyor tube disposed below the upper conveyor tube;
a chain disc conveyor having
multiple discs mounted in and arranged along the conveyor tubes at spaced intervals;
multiple chains linking the discs to form a chain loop extending through the two conveyor tubes;
two sprockets respectively disposed near the first end and the second end and engaged with the chain loop; and
a driving device connected to one of the sprockets and driving the sprocket to convey the discs moving along the upper conveyor tube from the first end to the second end and moving along the lower conveyor tube from the second end to the first end;
a rubber entry tube connected and communicating with the upper conveyor tube at a position near the first end;
a connecting tube connected and communicating with the upper and the lower conveyor tubes at a position spaced from the rubber entry tube near the second end;
a carbon export tube connected and communicating with the lower conveyor tube at a position away from the connecting tube near the first end; and
an oil gas outlet tube mounted on the top of the pyrolysis furnace unit and communicating with the conveyor tubes; and
a steam heating unit enclosing a segment of the conveyor tubes between the first end and the second end and having
a steam heating chamber enclosing the segment of the conveyor tubes to form a heating space surrounding the segment of the conveyor tubes;
a steam input and a steam output communicating with the steam heating chamber and respectively disposed near opposite ends of the steam heating chamber; and
multiple baffles arranged along the conveyor tubes at spaced intervals and arranged in staggered arrays to form a tortuous flowing path in the steam heating chamber from the steam input to the steam output.

2. The successive thermal pyrolysis apparatus as claimed in claim 1, wherein the steam heating unit has a thermal insulating layer covering the steam heating chamber.

3. The successive thermal pyrolysis apparatus as claimed in claim 2, wherein the thermal insulating layer of the steam heating unit has an outer layer made of carbon steel and an inner layer made of ceramic fiber.

4. The successive thermal pyrolysis apparatus as claimed in claim 1, wherein the steam heating chamber has multiple porous metal fillings filled in the heating space surrounding the conveyor tubes.

5. The successive thermal pyrolysis apparatus as claimed in claim 2, wherein the steam heating chamber has multiple porous metal fillings filled in the heating space surrounding the conveyor tubes.

6. The successive thermal pyrolysis apparatus as claimed in claim 3, wherein the steam heating chamber has multiple porous metal fillings filled in the heating space surrounding the conveyor tubes.

7. The successive thermal pyrolysis apparatus as claimed in claim 1, wherein the steam heating unit encloses the segment of the conveyor tubes between the rubber entry tube and the connecting tube.

8. The successive thermal pyrolysis apparatus as claimed in claim 2, wherein the steam heating unit encloses the segment of the conveyor tubes between the rubber entry tube and the connecting tube.

9. The successive thermal pyrolysis apparatus as claimed in claim 3, wherein the steam heating unit encloses the segment of the conveyor tubes between the rubber entry tube and the connecting tube.

10. The successive thermal pyrolysis apparatus as claimed in claim 4, wherein the steam heating unit encloses the segment of the conveyor tubes between the rubber entry tube and the connecting tube.

11. The successive thermal pyrolysis apparatus as claimed in claim 5, wherein the steam heating unit encloses the segment of the conveyor tubes between the rubber entry tube and the connecting tube.

12. The successive thermal pyrolysis apparatus as claimed in claim 6, wherein the steam heating unit encloses the segment of the conveyor tubes between the rubber entry tube and the connecting tube.
